(19) United States
(12) Patent Application Publication
(10) Pub. No.: US 2002/0176914 A1
(43) Pub. Date: Nov. 28, 2002

(54) Sandwich moisture transmission pocket and method of using same

(76) Inventors: Stacey Lee Kimball, Bedford, NH (US); Andre Philippe Desmarais, Candia, NH (US)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/862,716

(22) Filed: May 22, 2001

(51) Int. Cl. A23B 4/00

(52) U.S. Cl. 426/120

(57) ABSTRACT

A moisture transmission prevention barrier or pocket for separating the sandwich filling material from the bread to prevent any liquid or moisture, contained in the sandwich filling material, from being transferred to and/or absorbed by the bread during the temporary storage of the assembled sandwich prior to consumption by a purchaser. The moisture transmission prevention barrier or pocket is preferably manufactured from an FDA approved plastic material and has a suitably sized internal compartment to accommodate a desired quantity of the sandwich filling material therein. The moisture transmission prevention barrier or pocket/sandwich filling material unit is then received by a slot or recess formed in a piece of bread, or between inwardly facing surfaces of the two slices of bread, to from an assembled sandwich. Prior to consumption of the assembled sandwich by the purchaser, the moisture transmission prevention barrier or pocket is removed from the bread, e.g. inverted to transfer the sandwich filling material to the bread, and, thereafter, the prepared sandwich can be consumed by the purchaser. The invention also relates to a method of assembling a prepared sandwich, incorporating the moisture transmission prevention barrier or pocket, for subsequent sale at a remote location.

### FIELD OF THE INVENTION

The present invention relates to a moisture transmission barrier or impermeable pocket for a sandwich which prevents any liquid or fluid from the sandwich filling contents or material, e.g. mayonnaise, salad dressing, oil, olive oil, spice, seasoning, etc., from being transmitted to and absorbed by the bread of the sandwich, encasing the sandwich filling contents or material, thereby to improve the quality of the sandwich once consumed by a purchaser.

### BACKGROUND OF THE INVENTION

Currently, a variety of sandwiches are made at a production facility, packaged and distributed locally and regionally for sale in supermarkets, convenience stores, vending machines, etc. As these sandwiches are made beforehand, it may be several minutes to many hours, or possibly even a number of days, before the sandwich is purchased and consumed by a purchaser. Accordingly, there is a substantial amount of time during which any liquid or moisture, contained within the sandwich filling material of the sandwich, can be transferred to and/or absorbed by the surrounding bread which is in intimate contact with the sandwich filling material. This results in the bread becoming soggy which is undesirable. Such liquid absorption lowers the overall quality of the sandwich being consumed by the purchaser. In the event that the purchaser is dissatisfied with the quality of the purchased sandwich, this decreases the possibility that the same purchaser will purchase a similar brand of sandwich at a later date.

### SUMMARY OF THE INVENTION

Wherefore, it is an object of the present invention to overcome the above mentioned shortcomings and drawbacks associated with the prior art.

Another object of the present invention is to provide a moisture transmission prevention barrier or pocket, located between the sandwich filling materials and the surrounding bread, to essentially eliminate the possibility of any transmission of moisture or liquid from the sandwich filling material into the surrounding bread.

A further object of the present invention is to provide a low-cost, moisture transmission prevention barrier or pocket which is relatively inexpensive and simple to manufacture and relatively easy to utilize during production of a preassembled sandwich.

Yet another object of the present invention is to provide a moisture transmission prevention barrier or pocket which has an adequately sized internal compartment to easily and readily receive and accommodate a desired quantity of sandwich filling material for a sandwich.

A still further object of the present invention is to provide a thin, durable, moisture transmission prevention barrier or pocket which does not negatively effect, in any way, the quality or taste of the sandwich filling material of the sandwich and does not have any harmful side effects to humans.

A further object of the present invention is to provide a moisture transmission prevention barrier or pocket which allows the sandwich filling material to be removed from the bread to facilitate quick cooling of the sandwich filling material in the event that the temperature of the sandwich filling material has increased to a point which may compromise the integrity or consumability of the sandwich. It is to be appreciated that the temperature of the sandwich filling material is closely monitored at the production facility, during transportation and at the point of sale of the prepackaged sandwich to insure that the prepackaged sandwich is properly chilled to preserve the shelf life and minimize conditions which encourage growth of bacteria and other harmful diseases in the prepackage sandwich.

Another object of the present invention is to provide an arrangement which facilitates easy removal and separation of the sandwich filling material from the bread to allow warming or toasting of the bread, as desired, and also facilitates adding the chilled the sandwich filling material back onto the bread prior to the sandwich being consumed by an end user.

Yet another object of the present invention is to provide an arrangement which facilitate pasteurization of at least the sandwich filling material to improve the shelf life of the prepackaged sandwich, i.e. a prepackaged sandwich according to the present invention typically has a shelf life of about 7 days.

Yet another object of the present invention is to reinforce a bottom area of the moisture transmission prevention barrier or pocket, especially for moisture transmission prevention barriers or pockets having an axial length of about nine inches or greater, to prevent the barrier or pocket from sagging excessively and facilitate manipulation and handling of the moisture transmission prevention barrier or pocket during production.

The present invention also relates to a prepared sandwich for consumption by a purchaser, the prepared sandwich comprising: a piece of bread; a sandwich filling material being received by the piece of bread and a moisture transmission prevention pocket carrying the sandwich filling material, the moisture transmission prevention pocket separating the sandwich filling material from the piece of bread to prevent transfer of moisture from the sandwich filling material to the bread prior to consumption of the sandwich by the purchaser.

The present invention also relates to a method of manufacturing a prepared sandwich for consumption by a purchaser, the method comprising the steps of: providing a piece of bread; combining a sandwich filling material with the piece of bread and placing the sandwich filling material in a moisture transmission prevention pocket, the moisture transmission prevention pocket separating the sandwich filling material from the piece of bread to prevent transfer of moisture from the sandwich filling material to the bread prior to consumption of the sandwich by the purchaser.

### BRIEF DESCRIPTION OF THE DRAWINGS

The invention will now be described, by way of example, with reference to the accompanying drawings in which:

FIG. 1 is a diagrammatic front elevational view of one embodiment of a moisture transmission prevention barrier or pocket according to the present invention;

FIG. 1A is a diagrammatic front elevational view of a second embodiment of the moisture transmission prevention barrier or pocket according to the present invention;

FIG. 1B is a diagrammatic front elevational view of a third embodiment of the moisture transmission prevention barrier or pocket according to the present invention;

FIG. 1C is a diagrammatic front elevational view of a fourth embodiment of the moisture transmission prevention barrier or pocket according to the present invention;

FIG. 2 is a diagrammatic top plan view of the moisture transmission prevention barrier or pocket of FIG. 1 shown in the open state for receiving the sandwich filling material;

FIG. 3 is a diagrammatic front elevational view showing the moisture transmission prevention barrier or pocket, according to the present invention, accommodating a quantity of sandwich filling material prior to being received within a piece of bread;

FIG. 4 is a diagrammatic front elevational view showing the combined moisture transmission prevention barrier or pocket and sandwich filling material unit, according to the present invention, combined with bread to form an assembled sandwich which is packaged within a packaging material;

FIG. 4A is a diagrammatic cross sectional view of the assembled and packaged sandwich of FIG. 4;

FIG. 5 shows the moisture transmission prevention barrier or pocket and sandwich filling material unit removed from the bread by the purchaser;

FIG. 6 shows inversion of the moisture transmission prevention barrier or pocket and sandwich filling material unit to transfer the sandwich filling material to the sandwich and facilitate consumption of the sandwich by the purchaser;

FIG. 7 shows the resulting sandwich, following completion of transfer of the sandwich filling material, prior to consumption of the sandwich by the purchaser;

FIG. 8 is a diagrammatic front elevational view showing a second embodiment of a combined moisture transmission prevention barrier or pocket and sandwich filling material unit, according to the present invention, combined with two pieces of sliced bread to form an assembled sandwich which is packaged within a packaging material;

FIG. 8A is a diagrammatic cross sectional view of the assembled and packaged sandwich along section line 8A-8A of FIG. 8;

FIG. 9 is a diagrammatic front elevational view showing a variation of the second embodiment of FIG. 8; and

FIG. 9A is a diagrammatic cross sectional view of the assembled and packaged sandwich along section line 9A-9A of FIG. 9.

### DESCRIPTION OF THE PREFERRED EMBODIMENT(S)

Turning now to FIGS. 1 and 2, a detailed description concerning a first embodiment of the moisture transmission prevention barrier or pocket, according to the present invention, will now be provided. As can be seen in those two Figures, the moisture prevention barrier or pocket 2 comprises an elongate section of an FDA approved material such as a transparent polyethylene, polypropylene laminated plastics, nylon, etc. The moisture transmission prevention barrier or pocket 2 generally comprises a pair of mating or opposed sidewalls 4 and a transverse bottom seam 6 which closes one end 8 of the moisture transmission prevention barrier or pocket 2. The opposite end 10 of the moisture transmission prevention barrier or pocket 2 is open (see FIG. 2) to facilitate access to an internal compartment 12 located within the moisture transmission prevention barrier or pocket 2. This opening facilitates receiving the sandwich filling material 14 therein as will be discussed below in further detail.

With reference now to FIG. 1A, a second embodiment of the present invention will now be discussed. As this embodiment is closely related to the first embodiment, only the differences between the two embodiments will be discussed in detail. The major difference between the embodiment of FIG. 1A and that of FIG. 1 is that the transverse bottom seam 6, which closes the bottom end 8 of the moisture transmission prevention barrier or pocket 2, is replaced with a pair of opposed lateral seams 7 which form a pair of lateral tabs 9 on opposed sides of the moisture prevention barrier or pocket 2. These lateral tabs 9 have a width of about ¼ of an inch to about ½ of an inch or so and facilitate lifting, flipping, handling and/or manipulation of the moisture transmission prevention barrier or pocket 2, especially when filled with the sandwich filling material (not shown), and the importance of these tabs 9 will be discussed below in further detail. This embodiment, like the first embodiment, is also open at the top end 10, i.e. formed by the separate edges of the pair of mating sidewalls 4, and closed at the bottom, e.g. formed by a transverse fold of the pair of mating sidewalls 4.

With reference now to FIG. 1B, a third embodiment of the present invention will now be discussed. As this embodiment is closely related to the second embodiment, only the differences between the two embodiments will be discussed in detail. The major difference between the embodiment of FIG. 1B and that of FIG. 1A is that the moisture transmission prevention barrier or pocket 2 is not opened along the top, i.e. the top is closed or sealed. For example, a “tear away” elongate seal 11 may close the elongate length of the top of the moisture transmission prevention barrier or pocket 2 and this elongate seal 11 has an area of reduced thickness, or some other conventional arrangement to facilitate tearing away of this material which, in combination with the tabs 9 and the bottom fold, completely seals internal compartment 12 of the moisture transmission prevention barrier or pocket 2. Once the elongate seal 11 is torn away in a customary manner, this procedure forms an opening in the top end 10 of the moisture transmission prevention barrier or pocket 2 and facilitates access to the sandwich filling material 14. This embodiment ensures that the sandwich filling material 14, once located and sealed within the internal compartment 12 of the moisture transmission prevention barrier or pocket 2, in a conventional manner, is captively retained and sealed therein. Thus, if a formed prepackaged sandwich flips over or otherwise becomes oriented in a position which would normally cause some of the sandwich filling material 14 to be dislodged from the moisture transmission prevention barrier or pocket 2, the elongate seal prevents this from occurring. It is to be appreciated that the sandwich filling material 14 is enclosed and sealed withing the moisture transmission prevention barrier or pocket 2 during the manufacturing process of barrier or pocket, as will be discussed below in further detail. In all other respects, this embodiment is the same as the second embodiment.

When the user desires to consume the prepackaged sandwich, according to this embodiment, the elongate seal 11 is torn away and removed to provide access to the internal compartment 12 of the moisture transmission prevention barrier or pocket. Thereafter, this embodiment is utilized in the same manner as the first and second embodiments described above.

With reference now to FIG. 1C, a fourth embodiment of the present invention will now be discussed. As this embodiment is closely related to the second embodiment, only the differences between the two embodiments will be discussed in detail. The major difference between the embodiment of FIG. 1C and that of FIG. 1A is that one of the tabs 9′ (the left tab in FIGS. 1A and 1B and the left tab in FIG. 1C) is provided with a perforation or some other reduced area 7′ which facilitates tearing away or complete removal of the tab 9′ from a remainder of the moisture transmission prevention barrier or pocket 2 to completely open that lateral side of the moisture transmission prevention barrier or pocket 2—the purposed of the opening of the side will be discussed below in further detail. In all other respects, this embodiment is the same as the second embodiment.

The internal compartment 12 generally has a sandwich material capacity of between 20 and 50 cubic inches, preferably about 24 cubic inches, to accommodate a suitable portion of a desired sandwich filling material 14 therein. It is to be appreciated that the size of the internal compartment 12 can vary, from application to application, depending upon the size of the sandwich, e.g. a small sandwich, medium sandwich or large sandwich, and such variation in size would be readily apparent to those skilled in the art.

The moisture transmission prevention barrier or pocket 2 preferably has a length (L) of between 6 and 12 inches, most preferably a length (L) of about 7½ inches, and a height (H) of between 2 and 5 inches, most preferably a height (H) of about 2¼ inches. Preferably the wall of the moisture transmission prevention barrier or pocket 2 has a thickness of between 1 and 4 mils, and most preferably a thickness of about 2 mils.

It is to be appreciated that the moisture transmission prevention barrier or pocket 2 can be manufactured by a variety of different manufacturing processes but is preferably manufactured as a continuous length of plastic material (e.g. such as polyethylene) and engaged with transverse sealing equipment which cuts and seals a leading edge of the continuous length of material. Following the cutting and sealing action, the continuous roll of plastic material will be indexed a distance of about 2¼ inches and a further cutting and sealing will occur at the leading end of the continuous roll of plastic material. This cut/seal/index procedure is repeated a plurality of time to manufacture a plurality of the moisture transmission prevention barriers or pockets 2. It is to be appreciated that a variety of other conventional and well known manufacturing techniques can be employed for manufacturing the moisture transmission prevention barrier or pocket 2, according to the present invention.

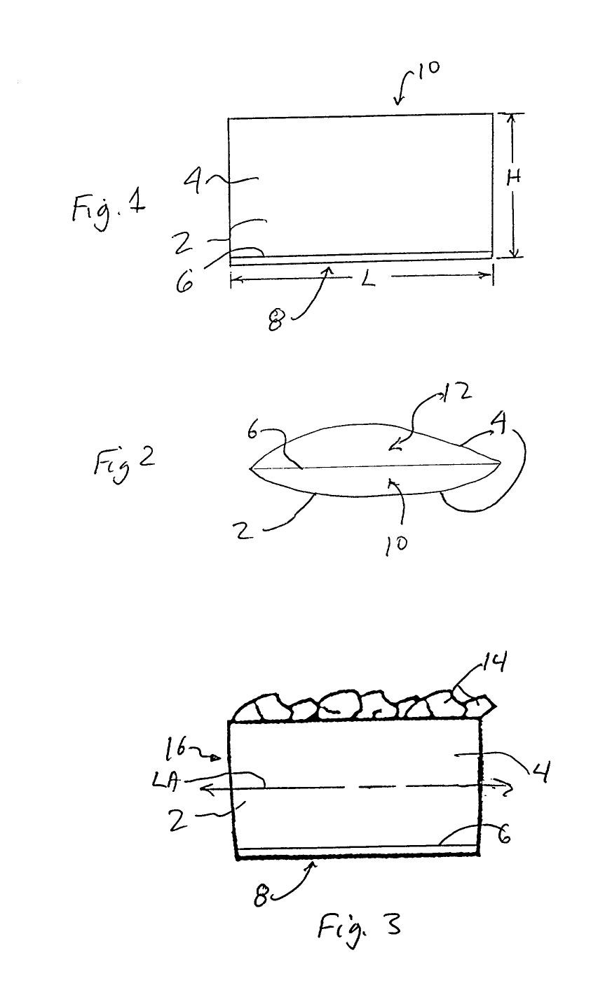

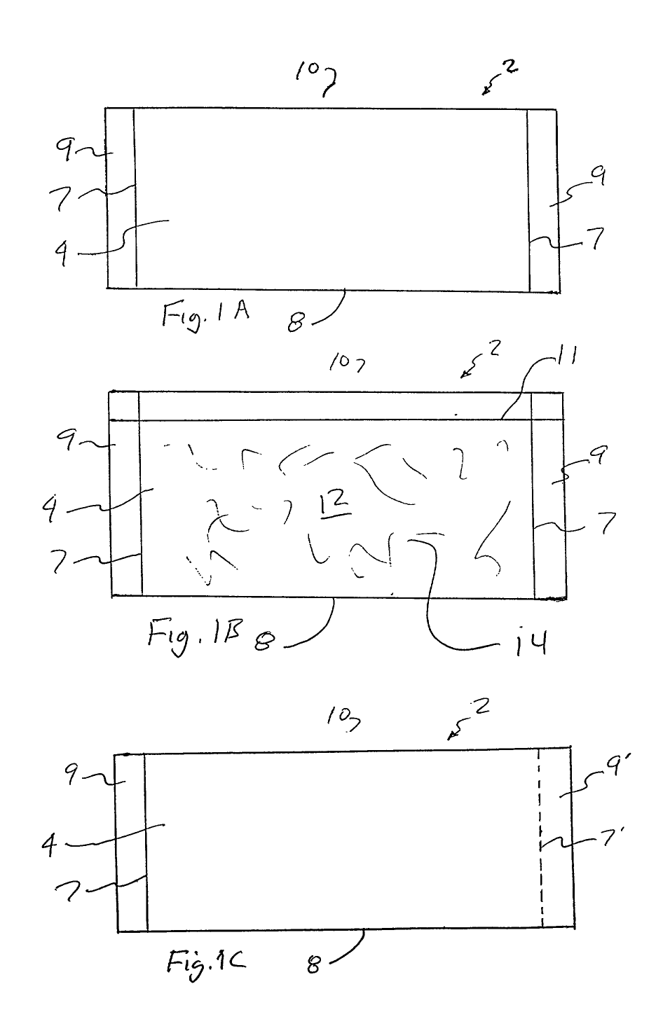

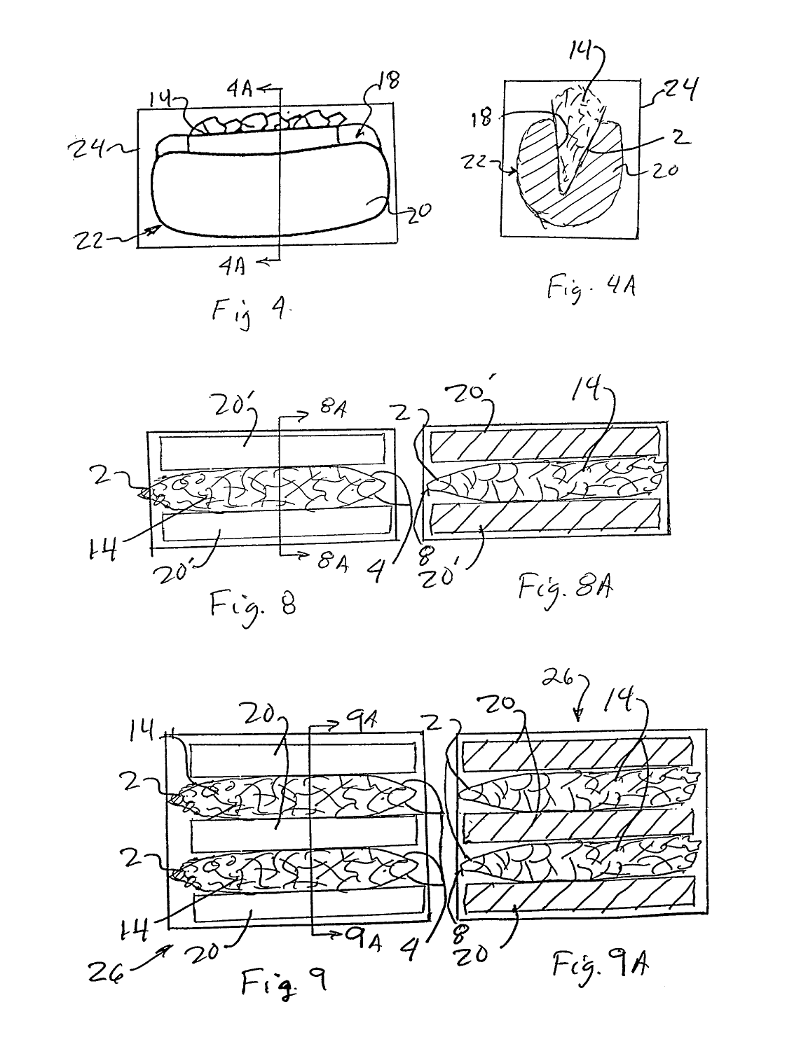

Following manufacture of the moisture transmission prevention barrier or pocket 2, a desired quantity of the sandwich filling contents or material 14 is placed in the internal compartment 12, either automatically or manually via the opening, to form a combined moisture transmission prevention barrier or pocket/sandwich filling material unit 16 (see FIG. 3). Once this occurs, the moisture transmission prevention barrier or pocket/sandwich filling material unit 16 can then conveyed to an assemble area or can be directly inserted or received by a slot or recess 18 of a piece of bread 20 (see FIGS. 4 and 4A), e.g. between the sidewalls of a “hot dog” style bun or roll, such that an exterior surface of the two opposed sidewalls 4 of the moisture transmission prevention barrier or pocket 2 are in direct contact with one of the inwardly facing surfaces of the bread while the inwardly facing surfaces are in direct contact with the sandwich filling material 14 and prevent any liquid ingredient(s) of the sandwich filling material 14 from being transferred or transmitted through the moisture transmission prevention barrier or pocket 2 to the bread 20. The prevention of liquid transfer prevents the bread 20 of the sandwich from absorbing liquid or moisture and becoming soggy which generally negatively impacts upon the overall quality of the assembled sandwich.

It is anticipated that the moisture transmission prevention barrier or pocket 2 can be effective in preventing any liquid or moisture from being transferred from the sandwich filling material 14 to the adjacent surface of the bread 20 for an adequate period of time, e.g. preferably at least 24 hours, more preferably at least 96 hours and most preferably at least 168 hours. Once the sandwich 22 is assembled, with the moisture transmission prevention barrier or pocket 2 separating the sandwich filling material 14 from a remainder of the bread 20, the assembly sandwich 22 can then be wrapped in conventional cellophane or packaged by some other customary packaging material 24 in a conventional manner.

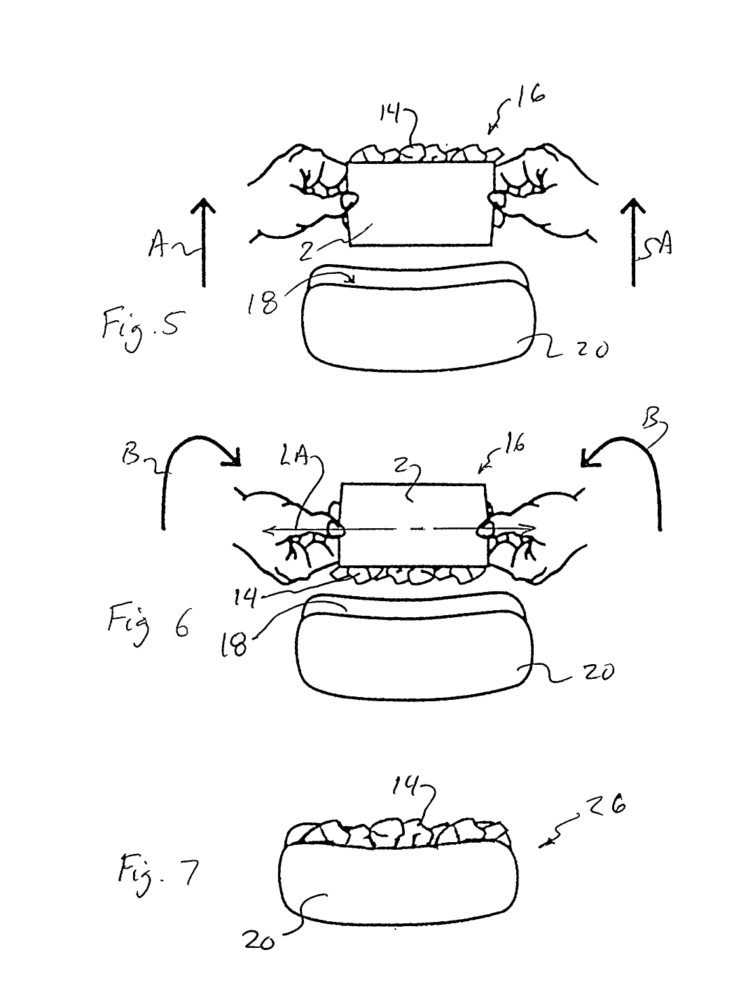

The prepackaged and assembled sandwich 22 of FIGS. 4 and 4A can then be distributed, through a normal distribution network to a variety of grocery stores, convenience stores, vending machines, etc. Once the assembled sandwich 22 is purchased by a purchaser, the purchaser will remove at least a portion of the surrounding packaging material 24 to facilitate access to the assembled sandwich 22. Once this has occurred, the purchaser will gently grab the moisture transmission prevention barrier or pocket 2, preferably by the tabs 9 for the second and third embodiments, to lift and separate the moisture transmission prevention barrier or pocket/sandwich filling material unit 16 and separate the same from the bread 20 (FIG. 5). Following such separation, the purchaser will rotate the moisture transmission prevention barrier or pocket/sandwich filling material unit 16, about its longitudinal axis LA (see FIG. 6), so that the moisture transmission prevention barrier or pocket 2 is rotated about 180 degrees and is thus orientated upside down. Such rotation facilitates transfer of the sandwich filling material 14, via gravity, into the slot or recess 18 of the bread 20 (see FIG. 7).

It is desirable for the moisture transmission prevention barrier or pocket 2 to be elevated only a small distance, e.g. between ½ of an inch or so to about 3 or 4 inches or so, to ensure that a majority of the sandwich filling material 14 is directly transferred and deposited into the slot or recess 18 of the bread 20. The purchaser can then squeeze the sidewalls of the moisture transmission prevention barrier or pocket 2 to force or remove any remaining sandwich filling material 14 which was not readily transferred to the slot or recess 18 by the mere inversion of the moisture transmission prevention barrier or pocket 2. Once this has occurred, the finally prepared and resulting sandwich 26 is then ready for consumption by the purchaser or some other third party.

When the user desires to consume a prepackaged sandwich, incorporating a moisture transmission prevention barrier or pocket 2 according to the fourth embodiment, the removable tab 9′ is torn away and removed to open one side of the moisture transmission prevention barrier or pocket 2. Once this has occurred, the user can grab the opposite tab 9 and squeeze his/her middle and index fingers against the exterior surface of the mating sidewalls 4, adjacent the remaining tab 9, and gradually pull the moisture transmission prevention barrier or pocket 2 laterally away from the bread and the sandwich filling material 14, once the sandwich is manufactured, to remove the moisture transmission prevention barrier or pocket 2 from a remainder of the sandwich thereby depositing the sandwich filling material 14 directly on the bread 20. Due to the moisture contained within the sandwich filling material 14, the sandwich filling material 14 slides relative easily with respect to the moisture transmission prevention barrier or pocket 2 is easily removed therefrom and deposited on the bread 20 without disrupting the sandwich filling material 14. This arrangement maintains the aesthetic appearance of the sandwich, since the sandwich filling material 14 is not inverted when depositing the sandwich filling material 14 on the bread 20. In the previous three embodiments, it is to be appreciated that the sandwich filling material 14 is inverted and placed on the bread to form the sandwich for consumption by the end user.

Following dispensing of the sandwich filling material 14, the moisture transmission prevention barrier or pocket 2 can then be properly disposed of, by the purchaser, with the remainder of the surrounding packaging material 24. If desired, the user can separate and remove the sandwich filling material 14 from the bread 20 to allow warming or toasting of the bread 20. Once this has occurred, the sandwich filling material 14 is then recombined with the bread and, thereafter, the sandwich being consumed by an end user. As will be appreciated from the above, since the sandwich filling material 14 has been partitioned and separated from the bread 20, via the moisture transmission prevention barrier or pocket 2, during the entire storage or shelf life of the assembled sandwich 22, the finally prepared and resulting sandwich 26 remains fresh and tastes like it was freshly made even though the assembled sandwich 22 may have been prepared a substantial number of hours or days prior to consumption by the purchaser.

With reference to FIGS. 8 and 8A, a second type of conventional sandwich, according to the present invention, will now be briefly discussed. As can be seen in these Figures, as with the previous embodiment, the moisture transmission prevention barrier or pocket 2 generally comprises a pair of mating sidewalls 4 and a transverse seam 6 which closes one end 8 of the moisture transmission prevention barrier or pocket 2. The opposite end 10 of the moisture transmission prevention barrier or pocket 2 is open to facilitate access to an internal compartment 12 within the moisture transmission prevention barrier or pocket 2. The opening facilitates receiving the sandwich filling material 14 therein.

The internal compartment 12 generally has a sandwich material capacity of between 20 and 40 cubic inches, preferably about 30 cubic inches, to accommodate a suitable portion of a desired sandwich filling material 14 therein. The moisture transmission prevention barrier or pocket 2 preferably has a length (L) of between 4 and 7 inches, most preferably a length (L) of about 6½ inches, and a height (H) of between 4 and 7 inches, most preferably a height (H) of about 6½ inches.

Preferably the wall of the moisture transmission prevention barrier or pocket 2 has a thickness of between 1 and 4 mils, and most preferably a thickness of about 2 mils.

As seen in FIGS. 8 and 8A, the moisture transmission prevention barrier or pocket 2 is shown sandwiched between two bread slices 20′ such that an inwardly facing surface of each slice of bread 20′ is in intimate contact with an exterior surface of one of side walls 4 to prevent the transfer of moisture therethrough, as with the above discussed arrangements.

The sandwich filling material 14 preferably comprises a mixture of at least one of crabmeat, lobster meat, tuna fish, seafood salad, ham salad, chicken salad, egg salad, etc. which is combined with at least one of mayonnaise, salad dressing, oil, olive oil, spices, seasoning, etc. If desired, lettuce, cheese, etc., can be packaged with the assembled sandwich 22 and combined with the sandwich filling material 14 prior to consumption of the sandwich by the purchase.

The assembled sandwich 22 is generally prepared from an elongate bun or roll, a hot dog roll or some other bread product which has an elongate central slot, slice, split, groove or recess 18, or some other internal cavity for accommodating the sandwich filling material 14. As such bread is conventional and well known in the art, a further detailed description concerning is not provided.

The moisture transmission barrier or pocket 2, according to the present invention, assists with improving the shelf life of the sandwich products. During manufacture of a sandwich, as well as during shipment, the temperature of the sandwich filling material 14 is generally closely monitored to ensure that it is sufficiently cooled to preserve the integrity and consumability of the product. In the event that either during the manufacture, shipping or storage of the assembled sandwich 22, it is determined that the temperature of the sandwich filling material 14 has sufficiently risen to justify concern, the entire sandwich or, if necessary, just the combined moisture transmission prevention barrier or pocket/sandwich filling material unit 16 can be removed from a remainder of the sandwich and placed directly on ice or in refrigerator to quickly lower the temperature of the sandwich filling material 14 to an acceptable temperature range. Once this has occurred, combined moisture transmission prevention barrier or pocket/sandwich filling material unit 16 is then redeposited back onto the sandwich. As noted above, the combined moisture transmission prevention barrier or pocket/sandwich filling material unit 16 also facilitates removal of the sandwich filling material 14 from a remainder of the bread so that the bread may be warmed up or toasted to suit the specific desire of the user prior to consuming the sandwich.

With reference to FIGS. 9 and 9A, a variation of the assembled sandwich 22 of FIG. 8 is shown, e.g. a club sandwich 28. According to this embodiment, three pieces of bread 20 sandwich two moisture transmission prevention barriers or pockets 2 therebetween. That is, each one of the two moisture transmission prevention barriers or pockets 2 is sandwiched between two adjacent pieces of sandwich bread 20. It is to be appreciated that each transmission prevention barrier or pocket 2 may contain the same or a different sandwich filling material 14, e.g. a first one of the transmission prevention barriers or pockets 2 may carry crabmeat, lobster meat, tuna fish, seafood salad, mayonnaise, salad dressing, oil, olive oil, etc., while the second of the transmission prevention barriers or pockets 2 may carry lettuce, tomatoes, pickles, cheese, grapes, celery, etc. Further variations of the present invention will be readily apparent to those skilled in this art.

Since certain changes may be made in the above described moisture transmission barrier or impermeable pocket and sandwich incorporating the same, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A prepared sandwich for consumption by a purchaser, the prepared sandwich comprising:
a piece of bread;
a sandwich filling material being received by the piece of bread; and
a moisture transmission prevention pocket carrying the sandwich filling material, the moisture transmission prevention pocket separating the sandwich filling material from the piece of bread to prevent transfer of moisture from the sandwich filling material to the bread prior to consumption of the sandwich by the purchaser.

2. The prepared sandwich according to claim 1, wherein a packaging material encases the bread, the sandwich filling material and the moisture transmission prevention pocket to prevent exposure thereof to a surrounding environment.

3. The prepared sandwich according to claim 1, wherein the moisture transmission prevention pocket comprises a flexible plastic container having a sidewall, the flexible plastic container is open at one end and is closed at the opposite end, and the open end defines an opening which provides access to an internal compartment of the moisture transmission prevention pocket to facilitate filling of a desired quantity of the sandwich filling material within the plastic container.

4. The prepared sandwich according to claim 3, wherein the moisture transmission prevention pocket has a length of between 6 and 12 inches and a height of between 2 and 5 inches.

5. The prepared sandwich according to claim 3, wherein the internal compartment of the moisture transmission prevention pocket is sized to accommodate a volume of between 20 and 50 cubic inches of the sandwich filling material.

6. The prepared sandwich according to claim 3, wherein the moisture transmission prevention pocket has a thickness of between 1 and 4 mils and has opposed tabs to facilitate manipulation of the moisture transmission prevention pocket.

7. The prepared sandwich according to claim 1, wherein the moisture transmission prevention pocket is manufactured from polyethylene and has a tear away seam to facilitate transfer of the sandwich filing material to the bread.

8. The prepared sandwich according to claim 1, wherein the sandwich filling material comprises one or more of the following ingredients: crabmeat, lobster meat, tuna fish, seafood salad, mayonnaise, salad dressing, olive oil, and oil.

9. The prepared sandwich according to claim 1, wherein the sandwich filling material comprises one or more of the following ingredients: crabmeat, lobster meat, tuna fish, seafood salad, chicken salad, ham salad, egg salad, mayonnaise, salad dressing, olive oil, and oil; and
the piece of bread comprises an elongate roll which has a recess for accommodating the sandwich filling material.

10. A prepared sandwich for consumption by a purchaser, the prepared sandwich comprising:
a piece of bread;
a sandwich filling material being received by piece of bread;
a moisture transmission prevention pocket carrying the sandwich filling material, the moisture transmission prevention pocket separating the sandwich filling material from the piece of bread to prevent transfer of moisture from the sandwich filling material to the bread prior to consumption of the sandwich by the purchaser;
a packaging material encasing the bread, the sandwich filling material and the moisture transmission prevention pocket to prevent exposure thereof to a surrounding environment;
the moisture transmission prevention pocket having a length of between 6 and 12 inches and a height of between 2 and 5 inches, and the internal compartment of the moisture transmission prevention pocket being sized to accommodate a volume of the sandwich filling material between 20 and 50 cubic inches; and
the moisture transmission prevention pocket is manufactured from polyethylene.

11. A method of manufacturing a prepared sandwich for consumption by a purchaser, the method comprising the steps of:
providing a piece of bread;
combining a sandwich filling material with the piece of bread; and
placing the sandwich filling material in a moisture transmission prevention pocket, the moisture transmission prevention pocket separating the sandwich filling material from the piece of bread to prevent transfer of moisture from the sandwich filling material to the bread prior to consumption of the sandwich by the purchaser.

12. The method of manufacturing a prepared sandwich according to claim 11, further comprising the step of encasing the bread, the sandwich filling material and the moisture transmission prevention pocket in a packaging material to prevent exposure thereof to a surrounding environment.

13. The method of manufacturing a prepared sandwich according to claim 11, further comprising the step of forming the moisture transmission prevention pocket from a flexible plastic container having a sidewall, the flexible plastic container is open at one end and is closed at the opposite end, and the open end defines an opening which provides access to an internal compartment of the moisture transmission prevention pocket to facilitate filling of a desired quantity of the sandwich filling material within the plastic container.

14. The method of manufacturing a prepared sandwich according to claim 13, further comprising the step of forming the moisture transmission prevention pocket with a length of between 6 and 12 inches and a height of between 2 and 5 inches.

15. The method of manufacturing a prepared sandwich according to claim 13, further comprising the step of sizing the internal compartment of the moisture transmission prevention pocket to accommodate a volume of between 20 and 50 cubic inches of the sandwich filling material.

16. The method of manufacturing a prepared sandwich according to claim 11, further comprising the step of forming the moisture transmission prevention pocket of a thickness of between 1 and 4 mils and providing the moisture transmission prevention pocket with a pair of opposed tabs to facilitate manipulation of the moisture transmission prevention pocket.

17. The method of manufacturing a prepared sandwich according to claim 11, further comprising the step of manufacturing the moisture transmission prevention pocket from polyethylene and providing the moisture transmission prevention pocket with a tear away seam to facilitate transfer of the sandwich filing material to the bread.

18. The method of manufacturing a prepared sandwich according to claim 11, further comprising the step of using comprises one or more of the following ingredients: crabmeat, lobster meat, tuna fish, seafood salad, mayonnaise, salad dressing, olive oil, and oil as the sandwich filling material.

19. The method of manufacturing a prepared sandwich according to claim 11, further comprising the step of using an elongate roll which has a recess therein for accommodating the sandwich filling material as the piece of bread.

20. The method of manufacturing a prepared sandwich according to claim 11, further comprising the step of using two slices of bread and accommodating the sandwich filling material between inwardly facing surfaces of the two slices of bread.
